(19) United States
(12) Patent Application Publication
(10) Pub. No.: US 2017/0293660 A1
(43) Pub. Date: Oct. 12, 2017

(54) INTENT BASED CLUSTERING

(71) Applicant: HEWLETT-PACKARD DEVELOPMENT COMPANY, L.P., Houston, TX (US)

(72) Inventors: Hila Nachlieli, Haifa (IL); Renato Keshet, Haifa (IL); George Forman, Port Orchard, WA (US)

(21) Appl. No.: 15/516,670

(22) PCT Filed: Oct. 2, 2014
(86) PCT No.: PCT/US2014/058852

§ 371 Date: Apr. 3, 2017

(51) Int. Cl. G06F 17/30

(52) U.S. Cl. CPC G06F 17/30522; G06F 17/30377

(57) ABSTRACT

According to an example, intent based clustering may include classifying objects based on training objects, and clustering the objects to determine initial clusters. The classification and initial clustering may be used to determine modified clusters.

### BACKGROUND

Clustering is typically the task of grouping a set of objects in such a way that objects in the same group (e.g., cluster) are more similar to each other than to those in other groups (e.g., clusters). In a typical scenario, a user provides a clustering application with a plurality of objects that are to be clustered. The clustering application typically generates clusters from the plurality of objects in an unsupervised manner, where the clusters may be of interest to the user.

### BRIEF DESCRIPTION OF DRAWINGS

Features of the present disclosure are illustrated by way of example and not limited in the following figure(s), in which like numerals indicate like elements, in which:

FIG. 1 illustrates an architecture of an intent based clustering apparatus, according to an example of the present disclosure;

FIG. 2 illustrates a graph of data that is to be clustered, according to an example of the present disclosure;

FIG. 3 illustrates a method for intent based clustering, according to an example of the present disclosure;

FIG. 4 illustrates further details of the method for intent based clustering, according to an example of the present disclosure;

FIG. 5 illustrates further details of the method for intent based clustering, according to an example of the present disclosure;

FIG. 6 illustrates further details of the method for intent based clustering, according to an example of the present disclosure; and

FIG. 7 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

In a clustering application that generates clusters in an unsupervised manner, the resulting clusters may not be useful to a user. For example, a clustering application may generate clusters for documents related to boats based on color (e.g., red, blue, etc.) based on the prevalence of color-related terms in the documents. However, the generated clusters may be irrelevant to an area of interest (e.g., sunken boats, boats run aground, etc.) of the user. In this regard, according to examples, an intent based clustering apparatus and a method for intent based clustering are disclosed herein to generate clusters that are relevant to a user. The relevance of the clusters to the user may be deduced from previously approved clusters on another part of given data that is used to generate the clusters. The data may be organized based on a plurality of attributes. For example, the data may be organized based on color, shape, size, and/or content. If a user creates a class that contains the red items, and another class that contains the blue items, the next cluster proposed by the apparatus and method disclosed herein will contain green items, and not, for example, rectangular items.

The apparatus and method disclosed herein may provide for organization of data in an efficient and interactive manner. The apparatus and method disclosed herein may also provide for new clusters in data, with the clusters being in alignment with a user's view of the data, as expressed in previously defined classes. The apparatus and method disclosed herein may learn the way that a user wants to organize data from previously defined classes, and determine new clusters that agree with the user's clustering expectations. The apparatus and method disclosed herein may provide for the combining of clustering and classification in order to provide clusters that match the way data is grouped in existing classes. The apparatus and method disclosed herein may be applied to a variety of forms of data, such as, for example, multidimensional real data. Thus data may be clustered in a way that agrees with, and/or continues previously defined classifications. For the apparatus and method disclosed herein, based on user interaction, initial clusters may be refined to match user preferences. The clustering implemented by the apparatus and method disclosed herein further adds efficiency to the clustering process, thus reducing inefficiencies related to hardware utilization, and reduction in processing time related to generation of the clusters.

According to an example, the apparatus disclosed herein may include a processor, and a memory storing machine readable instructions that when executed by the processor cause the processor to classify objects based on training objects, and determine directions of known classes related to the training objects and unlabeled objects based on the classification. Objects may include any type of elements that may be clustered. For example, objects may include samples of data, etc., that are to be clustered. A class may represent a group of objects within the same area of interest of a user, and a cluster may represent a group of objects that have been partitioned either in an unsupervised manner (clustering), or according to the apparatus and method disclosed herein, based on known classes. Training objects may represent objects that have been identified as representing a particular class. The training objects may be ascertained from user interaction related to the objects. The objects may include the training objects and unlabeled objects. As described herein, residual objects may represent a group of the objects that their likelihood (e.g., probability) of belonging to the known classes fails to meet a criterion. As described herein, candidate objects may represent a group of objects from the training objects and the residual objects. The machine readable instructions may further cluster the objects to determine initial clusters, and determine directions of the initial clusters. The direction of a cluster may include an (x,y) value that represents the cluster in some way, e.g., the centroid (average) of the x- and y-values of labeled training points having the same color/cluster. For each direction of a set of directions that include the directions of the known classes and the directions of the initial clusters, the machine readable instructions may assign a specified number of objects to a direction of the set of directions based on a likelihood of an object of the objects being in one of the known classes or in one of the initial clusters.

The machine readable instructions may further modify each direction of the set of directions based on the assignment of the specified number of objects, and modify the initial classes and clusters based on assignment of candidate objects to a correct class based on the determination of the classification of each direction of the set of directions. The machine readable instructions may assign objects to modified directions based on the classification of each direction of the set of directions to generate modified clusters and classes. The machine readable instructions may identify particular clusters from the modified clusters, e.g., clusters that include a specified number of minimum objects per cluster. The machine readable instructions may select a specified number of objects per cluster to represent each of the particular clusters. The machine readable instructions may identify clusters from the modified clusters that include a specified number of minimum objects per cluster by selecting the specified number of minimum objects per cluster that include a highest likelihood of belonging to the cluster.

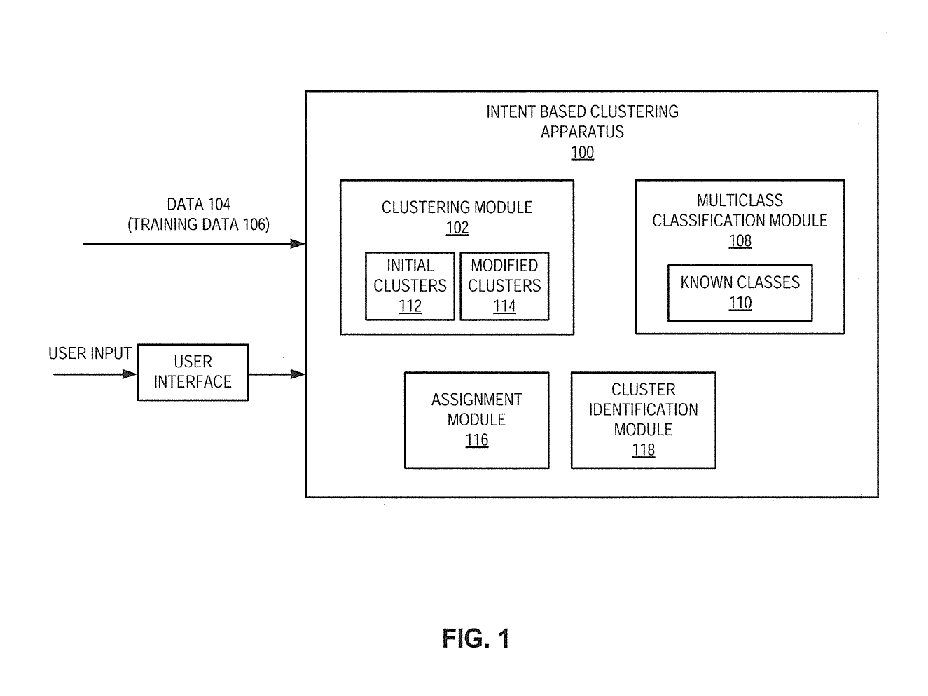

FIG. 1 illustrates an architecture of an intent based clustering apparatus (hereinafter also referred to as “apparatus 100”), according to an example of the present disclosure. Referring to FIG. 1, the apparatus 100 may include a clustering module 102 to assess data 104 that is to be clustered. The clustering module 102 may further assess training data 106 from the data 104 that is to be clustered. The training data 106 may be received via a user interface as user input related to identification of specific data from the data 104. A multiclass classification module 108 is to apply multiclass classification to classify the data 104 based on the training data 106, and determine directions of known classes 110 related to the training data 106 based on the multiclass classification. The clustering module 102 may cluster the data 104 to determine a specified number of initial clusters 112, and determine directions of the specified number of initial clusters 112. For each direction of a set of directions that include the directions of the known classes 110 and the directions of the specified number of initial clusters 112, the clustering module 102 may assign a specified number of points from the data to a direction of the set of directions based on a likelihood of a point of the points being in each one of the known classes 110 and/or in each one of the initial clusters 112. The multiclass classification module 108 may apply multiclass classification to learn a classification of each direction of the set of directions based on the assignment of the specified number of points. The multiclass classification module 108 may modify the initial clusters 112 (i.e., to generate modified clusters 114). In this regard, an assignment module 116 is to assign points from the data to the modified classes and clusters. A cluster identification module 118 is to identify a modified cluster as a relevant cluster. Further, the cluster identification module 118 may generate an output signal to display the relevant cluster.

The modules and other elements of the apparatus 100 may be machine readable instructions stored on a non-transitory computer readable medium. In this regard, the apparatus 100 may include or be a non-transitory computer readable medium. In addition, or alternatively, the modules and other elements of the apparatus 100 may be hardware or a combination of machine readable instructions and hardware.

Referring to FIG. 1, for the apparatus 100, the data 104 may include multidimensional real data in high dimensional Rⁿ space, where R is a real number, and n is a number of features (e.g., attributes) that describe each case. Each case may be described by a point in the Rⁿ space (thus, all cases include n number of features). Points in the Rⁿ space may represent cases, words, terms, instances of data, objects, etc., that are to be clustered.

For the high dimensional Rⁿ space, the points may be considered sparse. Based on the consideration that the points are sparse, a linear sub space separating any subset of points from other points may be identified. This assumption may lead to the conclusion that there are linear subspaces separating clusters that are of interest to a user, and appropriate clusters may be determined by operating in the reproducing kernel Hilbert space (RKHS) framework, and by using a linear kernel.

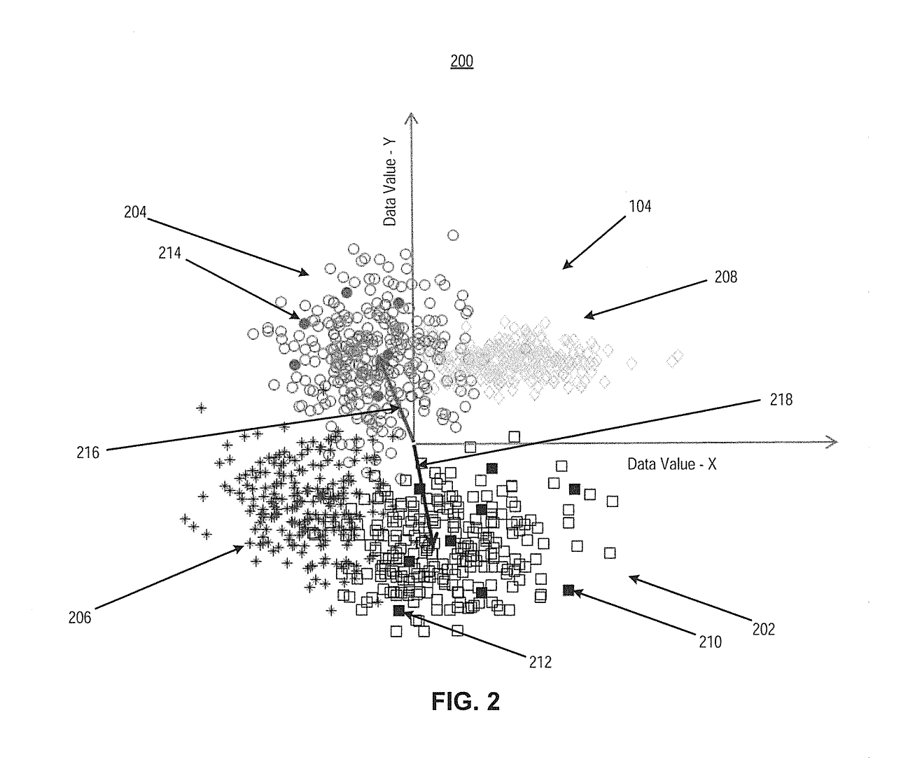

FIG. 2 illustrates a graph 200 of the data 104 that is to be clustered, according to an example of the present disclosure. The data 104 may be represented as a plurality of points as shown in FIG. 2. For the example of FIG. 2, the data 104 that is to be clustered may include four clusters shown at 202, 204, 206, and 208. The four clusters of FIG. 2 are provided for illustrative purposes, and the data 104 may include any number of clusters. A user may be unaware of the clusters prior to assignment of points related to certain clusters. For the example of FIG. 2, the clusters 202, 204, 206, and 208 may respectively represent data that is partitioned by the colors black, red, blue, and green. According to another example, the clusters 202, 204, 206, and 208 may respectively represent data that is partitioned by different types of products. A user may assign some points in the Rⁿ space to N₁ of the classes by identifying the assigned points according to a class. For example, a user may use the user interface to identify some points in the Rⁿ space to N₁ of the classes by identifying the assigned points according to a class. The assigned points may be designated as the training data 106. The classes may contain objects within the same areas of interest to a user, and the clusters may represent a group of points that have been partitioned according to the classes. The assigned points may be designated as labeled points P₁. For the example of FIG. 2, a user may assign nine training points that are related to the cluster shown at 202 (i.e., by assigning the nine points for the class corresponding to the cluster 202), and six training points related to the cluster shown at 204. For the example of FIG. 2, user-assigned training points that are related to the clusters 202 and 204 are illustrated as enlarged points (e.g., shown at 210, 212, 214, etc.).

The apparatus 100 may generate the clusters 202, 204, 206, and 208 based on the initial assignment of the points that are related to the clusters 202 and 204. The clusters 206 and 208 may represent information that the user is unaware of, but information that may be of relevance to the user based on the assignment of training points related to the clusters 202 and 204.

The multiclass classification module 108 may access the data 104 (i.e., training data 106 that includes the assigned points and unlabeled data that includes the remaining points), and implement a classification technique to implement subspace classification. For example, the multiclass classification module 108 may utilize Regularized Least Squares (RLS) classification to learn to classify the data 104 based on the training data 106. The multiclass classification module 108 may generate the likelihood of each point of the data 104 of being in a certain class. For example, the multiclass classification module 108 may generate the likelihood that a point is in the respective classes related to the clusters 202 and 204. With respect to the multiclass classification, each class j may be described by a direction dⱼ in the Rⁿ space, where the assignment of points to classes is based on their maximal projection on the dⱼ direction. The points that have a low projection on the dⱼ direction are determined to not be in the class being evaluated, even if there is no other class on which their projection is larger. The classification of the training data 106 may be used to determine the directions Dₖ of the known classes 110.

With respect to clustering of the data 104 that is performed by the clustering module 102 as described herein, residual data may be described as the test data (i.e., unlabeled data) from the data 104 that has a low likelihood of belonging to one of the known classes 110 (e.g., the respective classes related to the clusters 202 or 204 for the example of FIG. 2). The low likelihood may be determined with reference to a predetermined likelihood threshold for data that belongs to one of the known classes 110. For example, if the predetermined likelihood threshold is based on a median likelihood for all of the data for a class, in response to a determination that certain data of the test data has a likelihood of belonging to one of the known classes 110 that is less than the median likelihood (i.e., the predetermined likelihood threshold), that test data may be designated as residual data.

The clustering module 102 may determine clusters that are relevant to a user from the data 104. The clustering module 102 may use a clustering process, such as, for example, K-means clustering or MiniBatchKMeans clustering to generate N_{c} clusters (i.e., the initial clusters 112) that include N_{c} directions. For the example of FIG. 2, the clustering module 102 may generate N_{c} directions (i.e., twelve directions based on the specification of twelve clusters, or based on a determination by the clustering module 102). The clustering module 102 may further define a set of directions D to include directions Dₖ of known classes 110 (e.g., the two directions for the example of FIG. 2) and the N_{c} new directions D_{c} generated by the clustering module 102. Thus, for the example of FIG. 2, the set of directions D include fourteen directions, two directions from the multiclass classification module 108 and twelve directions from the clustering module 102.

With respect to determination of the set of directions D, the clustering module 102 may determine a matrix of cosine distances that contains the distances between all pairs of points (denoted a Laplacian matrix). The clustering module 102 may cluster columns of the Laplacian matrix to generate clusters of points with similarity in their proximity to other points. From these clusters, the largest N_{nc} clusters may be selected, and the directions from (0,0) to the centers of the largest N_{nc} clusters may be used to represent cluster directions D_{c}. The direction of a cluster may include an (x,y) value that represents the cluster in some way, e.g., the centroid (average) of the x- and y-values of labeled training points having the same color/cluster. The projection in the example of FIG. 2 is a measure of how close a data point is to a cluster direction (i.e., the closer the data point, the larger the projection). Thus, data points generally belong to a nearby direction (cluster). The union of all directions Dₖ and D_{c} may be determined as the directions D. For the example of FIG. 2, the cluster directions D_{c} for the clusters 202 and 204 are respectively shown at 216 and 218.

For each direction of the set of directions D, the assignment module 116 may determine the points that are more likely to represent a direction of the set of directions D. For the example of FIG. 2, for the two clusters 202 and 204 that are generated from the multiclass classification module 108, the assignment module 116 may assign the points from the training data 104 that more likely represent the two clusters from the multiclass classification module 108. Further, for the N_{c} clusters, the assignment module 116 may determine the points that have the highest likelihood of being in a particular one of the N_{c} clusters. Further, if a cluster has less than a predetermined number of points (e.g., 150 points for the example of FIG. 2), then the clustering module 102 may add candidate data from the data 104 with the highest projection for a particular cluster. The candidate data from the data 104 may include the training data 104 and the residual data. For each of the largest N_{nc} clusters, the clustering module 102 may identify N_{Pc} points for which the highest projection is on directions D_{c}. Those N_{Pc} points represent those clusters, and may be referred to by P_{c}. The clustering module 102 may mark the union of the points P₁ and P_{c} by P. For each of the points P, the projection on the directions D may be determined. The clustering module 102 may select the points whose highest projection is on d, and assign Nₘₐₓ points (e.g., 150 points for the example of FIG. 2) to each direction, where each point is assigned to one direction. The points in P₁ may be assigned to their original classes in direction Dₖ, even if the points in P₁ have a larger projection on another direction in D. Thus, for the example of FIG. 2, the clustering module 102 may assign the points in P₁ to the classes in direction Dₖ related to the clusters 202 and 204.

The clustering module 102 may apply multiclass classification to all of the directions (e.g., the fourteen directions for the example of FIG. 2) to learn the classification of each direction by the assigned points. That is, the clustering module 102 may utilize the directions related to the clusters (i.e., the clusters related to the known classes 110) that are generated based on the training data 106 for the clusters 202 and 204, and further, the directions related to the initial clusters 112 that are generated by the clustering module 102 as a new training input to the multiclass classification module 108, and apply multiclass classification to all of the directions related to these clusters (i.e., the fourteen clusters for the example of FIG. 2).

The assignment module 116 may re-assign the appropriate candidate data from the data 104 to the correct classes to refine the direction of the clusters that are generated based on the training data for the clusters 202 and 204, and further, the clusters that are generated by the clustering module 102. For the example of FIG. 2, the assignment module 116 may re-assign the appropriate candidate data from the data 104 for the fourteen clusters to the correct classes. In order to refine the directions of the initial clusters 112, the clustering module 102 may implement the following equation for all of the assigned points:

α=(c₁I−c₂K)⁻¹y Equation (1)

For Equation (1), K may represent the Laplacian matrix between assigned points, c₁ and c₂ may represent scalars, and y may represent a matrix with N₁+N_{nc} columns, where each point is represented by a row that includes a 1 in the column that represents the direction the point was assigned to, and 0 otherwise. The multiclass classification module 108 may solve Equation (1) for α, from which the multiclass classification module 108 may determine the refined direction.

Based on the assigned points, the cluster identification module 118 may select the modified clusters 114 with a predetermined minimum population. For the example of FIG. 2, the cluster identification module 118 may select the modified clusters 114 with a minimum population of twenty points. For each of the selected modified clusters 114, the cluster identification module 118 may select the points that have the highest likelihood of belonging to the selected modified cluster 114. That is, the cluster identification module 118 may select the points with the highest projections (i.e., likelihood) on the new directions of the modified clusters 114. The points with the highest projections on the new directions of the modified clusters 114 may represent each of the N_{nc} modified clusters. The N_{nc} modified clusters may represent the modified clusters 114 that are the highest likelihood clusters of interest to the user. For the example of FIG. 2, the N_{nc} modified clusters may be generated as the clusters 206 and 208. Any cluster with less than the predetermined number of points (e.g., twenty points) may be discarded.

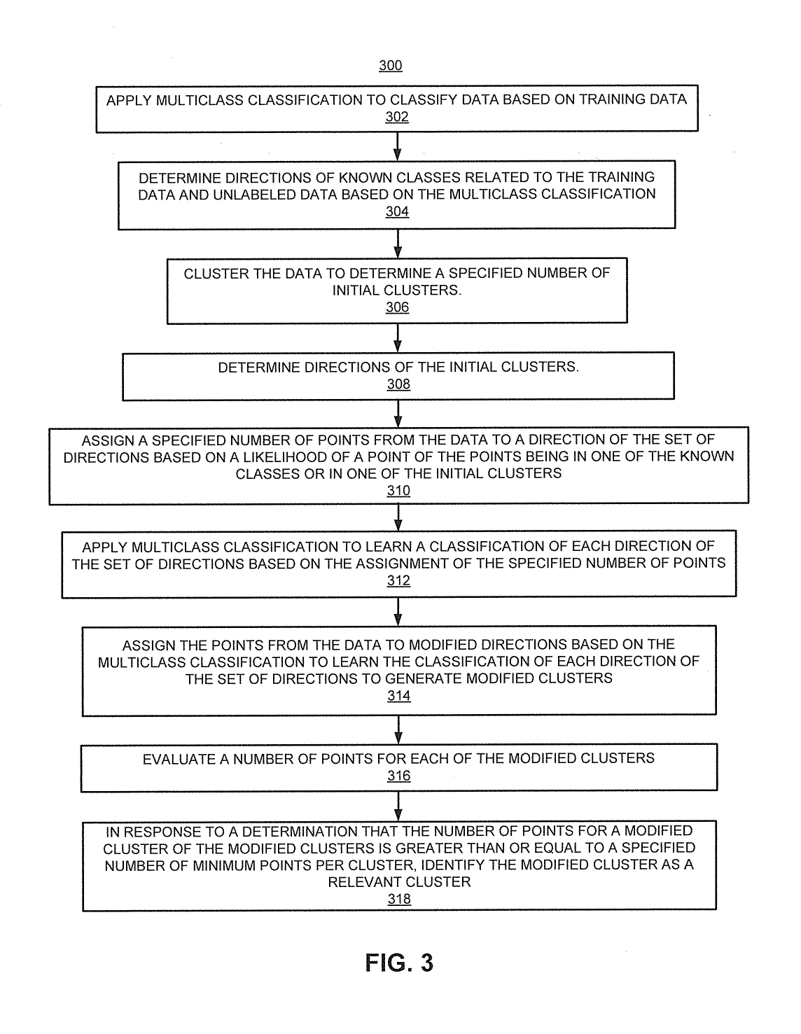

FIGS. 3-6 respectively illustrate flowcharts of methods 300, 400, 500, and 600 for intent based clustering, corresponding to the example of the intent based clustering apparatus 100 whose construction is described in detail above. The methods 300, 400, 500, and 600 may be implemented on the intent based clustering apparatus 100 with reference to FIGS. 1 and 2 by way of example and not limitation. The methods 300, 400, 500, and 600 may be practiced in other apparatus.

Referring to FIG. 3, for the method 300, at block 302, the method may include applying multiclass classification to classify data based on training data. The data may include the training data and unlabeled data. For example, as described herein with reference to FIGS. 1 and 2, the multiclass classification module 108 may apply multiclass classification to classify the data 104 based on the training data 106. The data 104 may include the training data 106 and unlabeled data (i.e., data other than the training data 106).

At block 304, the method may include determining directions of known classes related to the training data and unlabeled data based on the multiclass classification. For example, as described herein with reference to FIGS. 1 and 2, the multiclass classification module 108 may determine directions of the known classes 110 related to the training data 106 and unlabeled data based on the multiclass classification. As described herein, the directions of the known classes may be denoted Dₖ.

At block 306, the method may include clustering the data to determine a specified number of initial clusters. For example, as described herein with reference to FIGS. 1 and 2, the clustering module 102 may cluster the data 104 to determine a specified number of the initial clusters 112.

At block 308, the method may include determining directions of the specified number of initial clusters. For example, as described herein with reference to FIGS. 1 and 2, the clustering module 102 may determine directions of the specified number of initial clusters 112. As described herein, the directions of the specified number of initial clusters 112 may be denoted D_{c}.

At block 310, for each direction of a set of directions that include the directions of the known classes and the directions of the specified number of initial clusters, the method may include assigning a specified number of points from the data to a direction of the set of directions based on a likelihood of a point of the points being in one of the known classes or in one of the initial clusters. For example, as described herein with reference to FIGS. 1 and 2, for each direction of a set of directions that include the directions of the known classes 110 and the directions of the specified number of initial clusters 112, the clustering module 102 may assign a specified number of points from the data 104 to a direction of the set of directions based on a likelihood of a point of the points being in one of the known classes 110 or in one of the initial clusters 112. As described herein, the clustering module 102 may select the points whose highest projection is on d, and assign Nₘₐₓ points (e.g., 150 points for the example of FIG. 2) to each direction, where each point is assigned to one direction.

At block 312, the method may include applying multiclass classification to learn a classification of each direction of the set of directions based on the assignment of the specified number of points. For example, as described herein with reference to FIGS. 1 and 2, the clustering module 102 may apply multiclass classification to learn a classification of each direction of the set of directions based on the assignment of the specified number of points. As described herein, the clustering module 102 may apply multiclass classification to all of the directions (e.g., the fourteen directions for the example of FIG. 2) to learn the classification of each direction by the assigned points.

At block 314, the method may include assigning the points from the data to modified directions based on the multiclass classification to learn the classification of each direction of the set of directions to generate modified clusters. For example, as described herein with reference to FIGS. 1 and 2, the assignment module 116 may assign the points from the data 104 to modified directions based on the multiclass classification to learn the classification of each direction of the set of directions to generate the modified clusters 114. As described herein, the assignment module 116 may re-assign the appropriate candidate data from the data 104 to the correct classes to refine the direction of the clusters that are generated based on the training data for the clusters 202 and 204, and further, the clusters that are generated by the clustering module 102.

At block 316, the method may include evaluating a number of points for each of the modified clusters. For example, as described herein with reference to FIGS. 1 and 2, the cluster identification module 118 may evaluate a number of points for each of the modified clusters 114.

At block 318, in response to a determination that the number of points for a modified cluster of the modified clusters is greater than or equal to a specified number of minimum points per cluster, the method may include identifying the modified cluster as a relevant cluster. For example, as described herein with reference to FIGS. 1 and 2, the cluster identification module 118 may select the modified clusters 114 with a predetermined minimum population. For the example of FIG. 2, the cluster identification module 118 may select the modified clusters 114 with a minimum population of twenty points.

According to an example, the method 300 may include generating an output signal to display the relevant cluster.

According to an example, for the method 300, residual data may include data that includes a likelihood of belonging to one of the known classes that is below a specified likelihood threshold for data that is assigned to the one of the known classes. Further, according to an example, the specified likelihood threshold may be a median likelihood of the data that is assigned to the one of the known classes based on the multiclass classification to classify the data based on the training data.

According to an example, the method 300 may include iteratively determining the modified clusters to further modify the identification of the relevant cluster.

According to an example, for the method 300, clustering the data to determine a specified number of initial clusters may further include applying K-means clustering to cluster the data to determine the specified number of initial clusters.

According to an example, for the method 300, for each direction of a set of directions that include the directions of the known classes and the directions of the specified number of initial clusters, assigning a specified number of points from the data to a direction of the set of directions based on a likelihood of a point of the points being in one of the known classes or in one of the initial clusters may further include assigning the specified number of points from the data to the direction of the set of directions based on a highest likelihood of the point of the points being in the one of the known classes or in the one of the initial clusters.

According to an example, in response to a determination that the number of points for a modified cluster of the modified clusters is greater than or equal to a specified number of minimum points per cluster, for the method 300, identifying the modified cluster as a relevant cluster may further include selecting the specified number of minimum points per cluster that include a highest likelihood of belonging to the cluster.

According to an example, in response to a determination that the number of points for a modified cluster of the modified clusters is greater than or equal to a specified number of minimum points per cluster, for the method 300, identifying the modified cluster as a relevant cluster may further include determining if the number of points assigned to the modified cluster is less than the specified number of minimum points per cluster, and in response to a determination that the number of points assigned to the modified cluster is less than the specified number of minimum points per cluster, assigning additional points to represent the modified cluster based on a highest likelihood of the additional points representing the modified cluster.

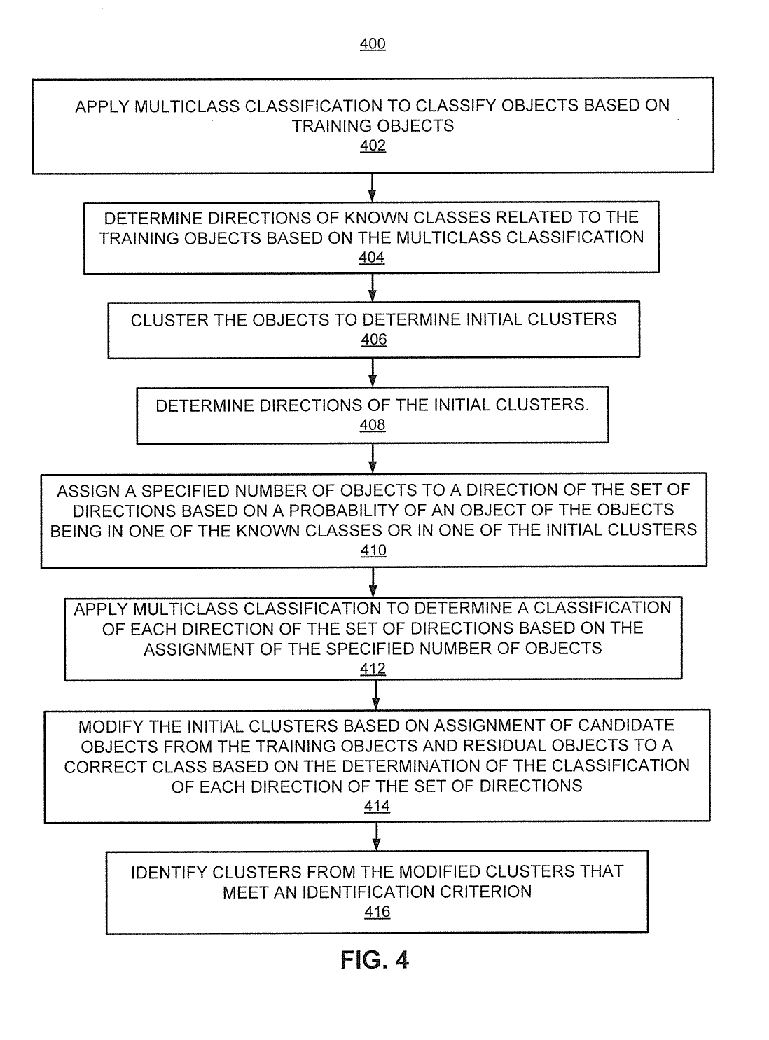

Referring to FIG. 4, for the method 400, at block 402, the method may include applying multiclass classification to classify objects based on training objects. For example, as described herein with reference to FIGS. 1 and 2, the multiclass classification module 108 may apply multiclass classification to classify objects based on training objects. Objects may include any type of elements that may be clustered. For example, objects may include samples of data, etc., that are to be clustered. The objects may include the training objects and unlabeled objects (i.e., objects other than the training objects).

At block 404, the method may include determining directions of known classes related to the training objects based on the multiclass classification. For example, as described herein with reference to FIGS. 1 and 2, the multiclass classification module 108 may determine directions of the known classes 110 related to the training objects based on the multiclass classification. As described herein, the directions of the known classes may be denoted Dₖ.

At block 406, the method may include clustering the objects to determine initial clusters. For example, as described herein with reference to FIGS. 1 and 2, the clustering module 102 may cluster the objects to determine the initial clusters 112.

At block 408, the method may include determining directions of the initial clusters. For example, as described herein with reference to FIGS. 1 and 2, the clustering module 102 may determine directions of the initial clusters 112. As described herein, the directions of the initial clusters 112 may be denoted D_{c}.

At block 410, for each direction of a set of directions that include the directions of the known classes and the directions of the initial clusters, the method may include assigning a specified number of objects to a direction of the set of directions based on a likelihood of an object of the objects being in one of the known classes or in one of the initial clusters. For example, as described herein with reference to FIGS. 1 and 2, for each direction of a set of directions that include the directions of the known classes 110 and the directions of the initial clusters 112, the clustering module 102 may assign a specified number of objects to a direction of the set of directions based on a likelihood of an object of the objects being in one of the known classes 110 or in one of the initial clusters 112. As described herein, the clustering module 102 may select the points whose highest projection is on d, and assign Nₘₐₓ points (e.g., 150 points for the example of FIG. 2) to each direction, where each point is assigned to one direction.

At block 412, the method may include applying multiclass classification to determine a classification of each direction of the set of directions based on the assignment of the specified number of objects. For example, as described herein with reference to FIGS. 1 and 2, the clustering module 102 may apply multiclass classification to determine a classification of each direction of the set of directions based on the assignment of the specified number of objects. As described herein, the clustering module 102 may apply multiclass classification to all of the directions (e.g., the fourteen directions for the example of FIG. 2) to learn the classification of each direction by the assigned points.

At block 414, the method may include modifying the initial clusters based on assignment of candidate objects from the training objects and residual objects to a correct class based on the determination of the classification of each direction of the set of directions. For example, as described herein with reference to FIGS. 1 and 2, the assignment module 116 may modify the initial clusters 112 based on assignment of candidate objects from the training objects and residual objects to a correct class based on the determination of the classification of each direction of the set of directions. As described herein, the assignment module 116 may re-assign the appropriate candidate data from the data 104 to the correct classes to refine the direction of the clusters that are generated based on the training data for the clusters 202 and 204, and further, the clusters that are generated by the clustering module 102.

At block 416, the method may include identifying clusters from the modified clusters that meet an identification criterion. For example, as described herein with reference to FIGS. 1 and 2, the cluster identification module 118 may identify clusters from the modified clusters that meet an identification criterion. For example, the cluster identification module 118 may select the modified clusters 114 with a predetermined minimum population. For the example of FIG. 2, the cluster identification module 118 may select the modified clusters 114 with a minimum population of twenty points.

According to an example, for the method 400, the identification criterion may include a specified number of minimum objects per cluster.

According to an example, for the method 400, assigning a specified number of objects to a direction of the set of directions based on a likelihood of an object of the objects being in one of the known classes or in one of the initial clusters may further include assigning the specified number of objects to the direction of the set of directions based on a highest likelihood of the object of the objects being in the one of the known classes or the one of the initial clusters.

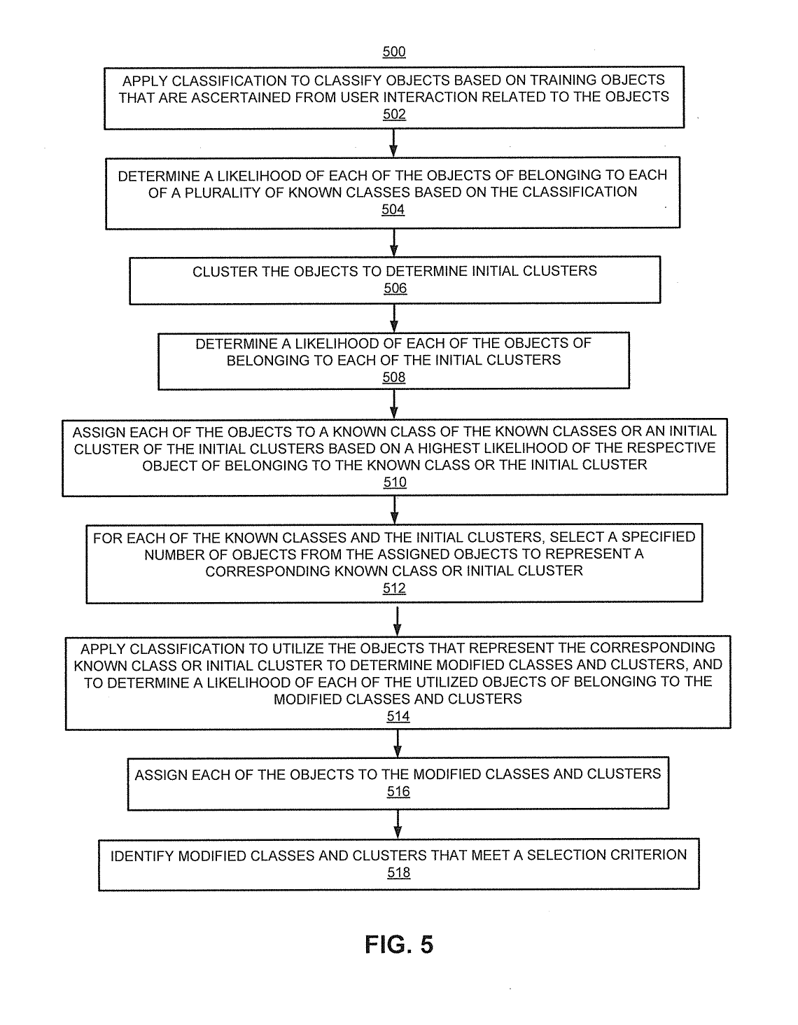

Referring to FIG. 5, for the method 500, at block 502, the method may include applying classification to classify objects based on training objects. For example, as described herein with reference to FIGS. 1 and 2, the multiclass classification module 108 may apply classification to classify objects based on training objects.

At block 504, the method may include determining a likelihood of each of the objects of belonging to each of a plurality of known classes based on the classification. For example, as described herein with reference to FIGS. 1 and 2, the multiclass classification module 108 may determine a likelihood (i.e., based on the determination of the directions) of each of the objects of belonging to each of a plurality of known classes 110 based on the classification.

At block 506, the method may include clustering the objects to determine initial clusters. For example, as described herein with reference to FIGS. 1 and 2, the clustering module 102 may cluster the objects to determine the initial clusters 112.

At block 508, the method may include determining a likelihood of each of the objects of belonging to each of the initial clusters. For example, as described herein with reference to FIGS. 1 and 2, the clustering module 102 may determine a likelihood (i.e., based on the determination of the directions) of each of the objects of belonging to each of the initial clusters 112.

At block 510, the method may include assigning each of the objects to a known class of the known classes or an initial cluster of the initial clusters based on a highest likelihood of the respective object of belonging to the known class or the initial cluster. For example, as described herein with reference to FIGS. 1 and 2, the clustering module 102 may assign each of the objects to a known class of the known classes 110 or an initial cluster of the initial clusters 112 based on a highest likelihood of the respective object of belonging to the known class or the initial cluster.

At block 512, for each of the known classes and the initial clusters, the method may include selecting a specified number of objects from the assigned objects to represent a corresponding known class or initial cluster. For example, as described herein with reference to FIGS. 1 and 2, the clustering module 102 may select a specified number of objects from the assigned objects to represent a corresponding known class or initial cluster.

At block 514, the method may include applying classification to utilize the objects that represent the corresponding known class or initial cluster to determine modified classes and clusters, and to determine a likelihood of each of the utilized objects of belonging to the modified classes and clusters. For example, as described herein with reference to FIGS. 1 and 2, the clustering module 102 may apply multiclass classification to utilize the objects that represent the corresponding known class or initial cluster to determine modified classes and clusters, and to determine a likelihood of each of the utilized objects of belonging to the modified classes and clusters.

At block 516, the method may include assigning each of the objects to the modified classes and clusters. An object may be assigned to the modified class or cluster for which the object has a maximal likelihood of belonging. For example, as described herein with reference to FIGS. 1 and 2, the assignment module 116 may assign each of the objects to the modified classes and clusters.

At block 518, the method may include identifying modified classes and clusters that meet a selection criterion. For example, as described herein with reference to FIGS. 1 and 2, the cluster identification module 118 may identify modified classes and clusters that meet a selection criterion.

According to an example, the method 500 may include generating an output signal to display the identified modified class and cluster.

According to an example, for the method 500, the selection criterion may include a specified number of minimum objects per modified class of the modified classes or modified cluster of the modified clusters.

According to an example, for the method 500, the specified number of minimum objects include a highest likelihood of belonging to a corresponding modified class of the modified classes or a corresponding modified cluster of the modified clusters.

According to an example, the method 500 may further include identifying candidate objects that include the training objects and residual objects that include a subset of the objects with a low likelihood of belonging to one of the known classes. Further, clustering the objects to determine initial clusters, determining a likelihood of each of the objects of belonging to each of the initial clusters, and assigning each of the objects to a known class of the known classes or an initial cluster of the initial clusters based on a highest likelihood of the respective object of belonging to the known class or the initial cluster may further include clustering the candidate objects to determine the initial clusters, determining the likelihood of each of the candidate objects of belonging to each of the initial clusters, and assigning each of the candidate objects to the known class of the known classes or the initial cluster of the initial clusters based on the highest likelihood of the respective object of belonging to the known class or the initial cluster.

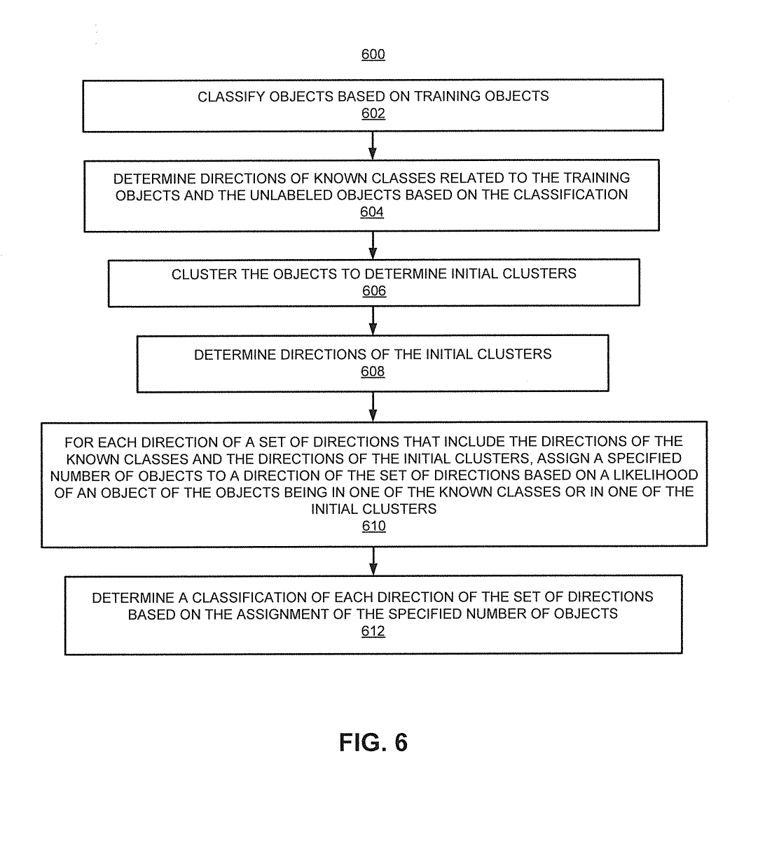

Referring to FIG. 6, for the method 600, at block 602, the method may include classifying objects based on training objects, where the training objects are ascertained from user interaction related to the objects, and where the objects includes the training objects and unlabeled objects. For example, as described herein with reference to FIGS. 1 and 2, the multiclass classification module 108 may apply multiclass classification to classify objects based on training objects.

At block 604, the method may include determining directions of known classes related to the training objects and the unlabeled objects based on the classification. For example, as described herein with reference to FIGS. 1 and 2, the multiclass classification module 108 may determine directions of known classes 110 related to the training objects and the unlabeled objects based on the classification.

At block 606, the method may include clustering the objects to determine initial clusters. For example, as described herein with reference to FIGS. 1 and 2, the clustering module 102 may cluster the objects to determine the initial clusters 112.

At block 608, the method may include determining directions of the initial clusters. For example, as described herein with reference to FIGS. 1 and 2, the clustering module 102 may determine directions of the initial clusters 112. As described herein, the directions of the initial clusters 112 may be denoted D_{c}.

For each direction of a set of directions that include the directions of the known classes and the directions of the initial clusters, at block 610, the method may include assigning a specified number of objects to a direction of the set of directions based on a likelihood of an object of the objects being in one of the known classes or in one of the initial clusters. For example, as described herein with reference to FIGS. 1 and 2, for each direction of a set of directions that include the directions of the known classes 110 and the directions of the initial clusters 112, the clustering module 102 may assign a specified number of objects to a direction of the set of directions based on a likelihood of an object of the objects being in one of the known classes 110 or in one of the initial clusters 112. As described herein, the clustering module 102 may select the points whose highest projection is on d, and assign Nₘₐₓ points (e.g., 150 points for the example of FIG. 2) to each direction, where each point is assigned to one direction.

At block 612, the method may include determining a classification of each direction of the set of directions based on the assignment of the specified number of objects. For example, as described herein with reference to FIGS. 1 and 2, the clustering module 102 may apply multiclass classification to determine a classification of each direction of the set of directions based on the assignment of the specified number of objects. As described herein, the clustering module 102 may apply multiclass classification to all of the directions (e.g., the fourteen directions for the example of FIG. 2) to learn the classification of each direction by the assigned points.

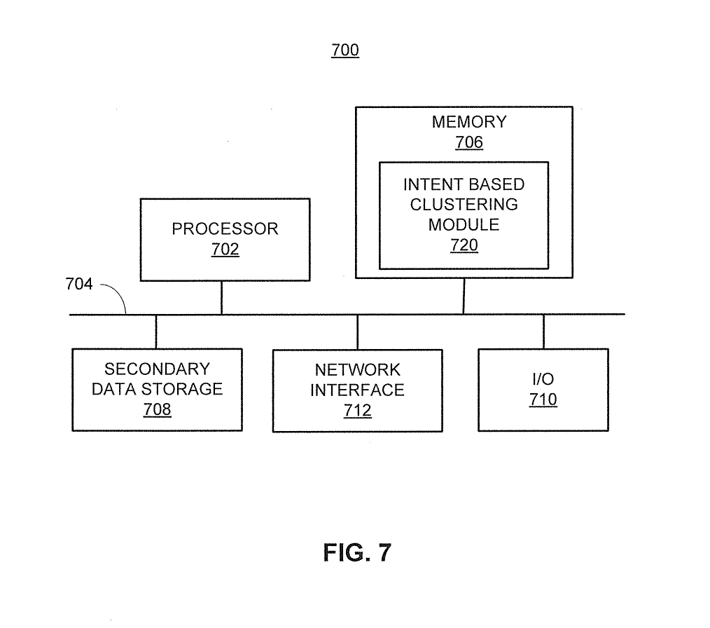

FIG. 7 shows a computer system 700 that may be used with the examples described herein. The computer system 700 may represent a generic platform that includes components that may be in a server or another computer system. The computer system 700 may be used as a platform for the apparatus 100. The computer system 700 may execute, by a processor (e.g., a single or multiple processors) or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 700 may include a processor 702 that may implement or execute machine readable instructions performing some or all of the methods, functions and other processes described herein. Commands and data from the processor 702 may be communicated over a communication bus 704. The computer system may also include a main memory 706, such as a random access memory (RAM), where the machine readable instructions and data for the processor 702 may reside during runtime, and a secondary data storage 708, which may be non-volatile and stores machine readable instructions and data. The memory and data storage are examples of computer readable mediums. The memory 706 may include an intent based clustering module 720 including machine readable instructions residing in the memory 706 during runtime and executed by the processor 702. The intent based clustering module 720 may include the modules of the apparatus 100 shown in FIG. 1.

The computer system 700 may include an I/O device 710, such as a keyboard, a mouse, a display, etc. The computer system may include a network interface 712 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for intent based clustering, the method comprising:
applying, by a processor, multiclass classification to classify data based on training data that is ascertained from user interaction related to the data that includes the training data and unlabeled data;
determining directions of known classes related to the training data and the unlabeled data based on the multiclass classification;
clustering the data to determine a specified number of initial clusters;
determining directions of the initial clusters;
for each direction of a set of directions that include the directions of the known classes and the directions of the initial clusters, assigning a specified number of points from the data to a direction of the set of directions based on a likelihood of a point of the points being in one of the known classes or in one of the initial clusters;
applying multiclass classification to learn a classification of each direction of the set of directions based on the assignment of the points;
assigning the points from the data to modified directions based on the multiclass classification to learn the classification of each direction of the set of directions to generate modified clusters;
evaluating a number of points for each of the modified clusters; and
in response to a determination that the number of points for a modified cluster of the modified clusters is greater than or equal to a specified number of minimum points per cluster, identifying the modified cluster as a relevant cluster.

2. The method of claim 1, wherein applying multiclass classification to classify data based on training data further comprises:
applying Regularized Least Squares (RLS) classification to classify the data based on the training data.

3. The method of claim 1, further comprising:
iteratively determining the modified clusters to further modify the identification of the relevant cluster.

4. The method of claim 1, wherein clustering the data to determine a specified number of initial clusters further comprises:
applying K-means or MiniBatchKMeans clustering to cluster the data to determine the specified number of initial clusters.

5. The method of claim 1, wherein for each direction of a set of directions that include the directions of the known classes and the directions of the specified number of initial clusters, assigning a specified number of points from the data to a direction of the set of directions based on a likelihood of a point of the points being in one of the known classes or in one of the initial clusters further comprises:
assigning the specified number of points from the data to the direction of the set of directions based on a highest likelihood of the point of the points being in the one of the known classes or in the one of the initial clusters.

6. The method of claim 1, wherein in response to a determination that the number of points for a modified cluster of the modified clusters is greater than or equal to a specified number of minimum points per cluster, identifying the modified cluster as a relevant cluster further comprises:
determining if the number of points assigned to the modified cluster is less than the specified number of minimum points per cluster; and
in response to a determination that the number of points assigned to the modified cluster is less than the specified number of minimum points per cluster, assigning additional points to represent the modified cluster based on a highest likelihood of the additional points representing the modified cluster.

7. An intent based clustering apparatus comprising:
a processor; and
a memory storing machine readable instructions that when executed by the processor cause the processor to:
classify objects based on training objects, wherein the training objects are ascertained from user interaction related to the objects, and wherein the objects includes the training objects and unlabeled objects;
determine directions of known classes related to the training objects and the unlabeled objects based on the classification;
cluster the objects to determine initial clusters;
determine directions of the initial clusters;
for each direction of a set of directions that include the directions of the known classes and the directions of the initial clusters, assign a specified number of objects to a direction of the set of directions based on a likelihood of an object of the objects being in one of the known classes or in one of the initial clusters; and
determine a classification of each direction of the set of directions based on the assignment of the specified number of objects.

8. The intent based clustering apparatus according to claim 7, wherein the machine readable instructions are further to:
assign objects to modified directions based on the classification of each direction of the set of directions to generate modified clusters; and
identify clusters from the modified clusters that include a specified number of minimum objects per cluster by selecting the specified number of minimum objects per cluster that include a highest likelihood of belonging to the cluster.

9. The intent based clustering apparatus according to claim 7, wherein the machine readable instructions to assign a specified number of objects to a direction of the set of directions based on a likelihood of an object of the objects being in one of the known classes or in one of the initial clusters further comprise instructions to:
assign the specified number of objects to the direction of the set of directions based on a highest likelihood of the object of the objects being in the one of the known classes or the one of the initial clusters.

10. The intent based clustering apparatus according to claim 8, wherein the machine readable instructions are further to:
iteratively determine the modified clusters to further modify the identification of the clusters from the modified clusters.

11. The intent based clustering apparatus according to claim 8, wherein the machine readable instructions are further to:
determine if a number of objects assigned to a modified cluster of the modified clusters is less than the specified number of minimum objects per cluster; and
in response to a determination that the number of objects assigned to the modified cluster of the modified clusters is less than the specified number of minimum objects per cluster, assign additional objects to represent the modified cluster based on a highest likelihood of the additional object representing the modified cluster.

12. A non-transitory computer readable medium having stored thereon machine readable instructions to provide intent based clustering, the machine readable instructions, when executed, cause a processor to:
apply classification to classify objects based on training objects that are ascertained from user interaction related to the objects;
determine a likelihood of each of the objects of belonging to each of a plurality of known classes based on the classification;
cluster the objects to determine initial clusters;
determine a likelihood of each of the objects of belonging to each of the initial clusters;
assign each of the objects to a known class of the known classes or an initial cluster of the initial clusters based on a highest likelihood of the respective object of belonging to the known class or the initial cluster;
for each of the known classes and the initial clusters, select a specified number of objects from the assigned objects to represent a corresponding known class or initial cluster;
apply classification to utilize the objects that represent the corresponding known class or initial cluster to determine modified classes and clusters, and to determine a likelihood of each of the utilized objects of belonging to the modified classes and clusters;
assign each of the objects to the modified classes and clusters, wherein an object is assigned to the modified class or cluster for which the object has a maximal likelihood of belonging; and
identify modified classes and clusters that meet a selection criterion.

13. The non-transitory computer readable medium according to claim 12, wherein the machine readable instructions are further to:
identify candidate objects that include the training objects and residual objects that include a subset of the objects with a low likelihood of belonging to one of the known classes, wherein the machine readable instructions to cluster the objects to determine initial clusters, determine a likelihood of each of the objects of belonging to each of the initial clusters, and assign each of the objects to a known class of the known classes or an initial cluster of the initial clusters based on a highest likelihood of the respective object of belonging to the known class or the initial cluster further comprise instructions to:
cluster the candidate objects to determine the initial clusters;
determine the likelihood of each of the candidate objects of belonging to each of the initial clusters; and
assign each of the candidate objects to the known class of the known classes or the initial cluster of the initial clusters based on the highest likelihood of the respective object of belonging to the known class or the initial cluster.

14. The non-transitory computer readable medium according to claim 12, wherein the machine readable instructions are further to:
iteratively determine the modified classes and clusters to further modify the identification of the modified classes and clusters.

15. The non-transitory computer readable medium according to claim 12, wherein the selection criterion includes a specified number of minimum objects per modified class of the modified classes or modified cluster of the modified clusters.
